(19) United States
(12) Patent Application Publication
(10) Pub. No.: US 2013/0133395 A1
(43) Pub. Date: May 30, 2013

(54) Stamping Die of Joining Backplane and Processing Method of Joining Backplane

(71) Applicants: Yi-cheng Kuo, Shenzhen (CN); Gege Zhou, Shenzhen (CN)

(72) Inventors: Yi-cheng Kuo, Shenzhen (CN); Gege Zhou, Shenzhen (CN)

(21) Appl. No.: 13/378,108

(22) PCT Filed: Dec. 2, 2011
(86) PCT No.: PCT/CN2011/083336

§ 371 Date: Dec. 14, 2011

(30) Foreign Application Priority Data
Nov. 25, 2011 (CN) 201110382274.8

(51) Int. Cl. B21D 37/16; B23P 11/00

(52) U.S. Cl. 72/342.3; 29/428

(57) ABSTRACT

The present invention discloses a stamping die of a joining backplane and a processing method of a joining backplane. The processing method of the joining backplane, comprising: plates of the heatsink plate and the supporting plate are put into the same die for processing; then, the heatsink plate and the supporting plate, which are processed, are joined and fixed. In the present invention, because the heatsink plate and the supporting plate are processed simultaneously on one set of dies, the original processing courses of two plates are merged for reducing half of the processing steps. In addition, because the heatsink plate and the supporting plate are simultaneously processed in the same die, the two plates have good consistency and better planeness in joining.

### TECHNICAL FIELD

The present invention relates to the field of liquid crystal displays, and more particularly to a stamping die of a joining backplane and a processing method of a joining backplane.

### BACKGROUND

An LCD device includes a display panel and a backlight module for providing a light source to the display panel, wherein the bottom of the backlight module is provided with a backplane used for supporting internal devices and sealing the module and providing necessary protection. The existing backplane is generally made of the same material; the material used is an aluminum plate, an iron plate or plastics. If the whole backplane is made of the iron plate, a radiating element shall be added, causing increase of cost; if the whole backplane is made of the aluminum plate, the radiating element is not added and used; although the heat conduction effect of the aluminum plate is better than the heat conduction effect of the iron plate, only a part of the backplane performs a radiation action and the other part performs a supporting action instead of the radiation action; thus, the cost is still higher.

To solve the problem of overhigh cost of the backplane, the applicant applied a backplane of a backlight module, a backlight module and an LCD device on 12th of October; the application number is 201110308489.5. The application discloses a backplane structure formed by a heatsink plate and a supporting plate. Concrete example: because the price of the aluminum plate is higher than the price of the iron plate, the part of the backplane without performing the radiating action can be made of the iron plate to form the supporting plate; the part positioned in the radiating area is still made of the aluminum plate to form the heatsink plate; the heatsink plate and the supporting plate are joined to form the joining backplane of compound material (as shown in FIG. 1 and FIG. 2).

The existing joining backplane respectively adopts two sets of dies, so that two production lines are occupied; each of two backplanes has seven projects, and then two backplanes need fourteen projects; when the last joining project is added, fifteen projects in total are needed; thus, a large amount of cost is increased.

### SUMMARY

The aim of the present invention is to provide a stamping die of a joining backplane capable of simplifying processing steps and a processing method of a joining backplane.

The aim of the present invention is achieved by the following technical schemes.

A stamping die of a joining backplane, comprising a plurality of backplane figures which comprise a plurality of sub backplanes and sub figures thereof of joints.

Preferably, each sub backplane comprises a heatsink plate and a supporting plate. This is a concrete forming mode of the backplane figures; the backplane material can be pertinently selected according to the functions of the backplane, which is beneficial to cost reduction.

Preferably, sub figures of the heatsink plate and the supporting plate are identical and the identical sub figures can be simplified in design to reduce the design cost.

Preferably, the sub figures of the heatsink plate and the supporting plate of the joints comprise figures of reinforcing ribs. The reinforcing ribs are added in the joints for enhancing the strength of the joints, improving the planeness of the backplane and ensuring the image quality of the module.

A processing method of a joining backplane, comprising the following steps:

A: Plates of the heatsink plate and the supporting plate are put into the same die for processing;

B: The heatsink plate and the supporting plate, which are processed, are joined and fixed.

Preferably, the heatsink plate and the supporting plate are fixed in the mode of riveting. This is a concrete example of the heatsink plate and the supporting plate.

Preferably, the heatsink plate and the supporting plate are fixed in the mode of screwed connection. This is another concrete example of the heatsink plate and the supporting plate.

Preferably, the heatsink plate and the supporting plate are fixed in the mode of bonding by super glue. This is the third concrete example of the heatsink plate and the supporting plate.

Preferably, the heatsink plate and the supporting plate are fixed in the mode of lock seaming; the heatsink plate and the supporting plate are folded in the joint to form clamping slots and clamping plates; the clamping plate of the heatsink plate is embedded into the clamping slot of the supporting plate; meanwhile, the clamping plate of the supporting plate is also embedded into the clamping slot of the heatsink plate to form the lock seaming connection. In the example, no other fixed material is used, thereby reducing the assembly steps and enhancing the assembly efficiency.

In the present invention, because the heatsink plate and the supporting plate are processed simultaneously on one set of dies, the original processing courses of two plates are merged for reducing half of the processing steps. In addition, because the heatsink plate and the supporting plate are simultaneously processed in the same die, the two plates have good consistency and better planeness in joining

### BRIEF DESCRIPTION OF FIGURES

FIG. 1 is a schematic diagram of separating a heatsink plate and a supporting plate;

FIG. 2 is a schematic diagram of a heatsink plate and a supporting plate which are joined;

FIG. 3 is a schematic diagram of the existing processing mode of a heatsink plate;

FIG. 4 is a schematic diagram of the existing processing mode of a supporting plate;

FIG. 5 is a schematic diagram of a processing mode in the present invention;

FIG. 6 is a schematic diagram of fixing a heatsink plate and a supporting plate in a non-rivet riveting mode in the present invention;

FIG. 7 is a schematic diagram of fixing a heatsink plate and a supporting plate in a riveting mode of rivets in the present invention;

FIG. 8 is a schematic diagram of fixing a heatsink plate and a supporting plate in a bonding mode of super glue in the present invention;

FIG. 9 is a schematic diagram of fixing a heatsink plate and a supporting plate in a screwed connection mode in the present invention;

FIG. 10 is a schematic diagram of fixing a heatsink plate and a supporting plate in a lock seaming connection mode in the present invention;

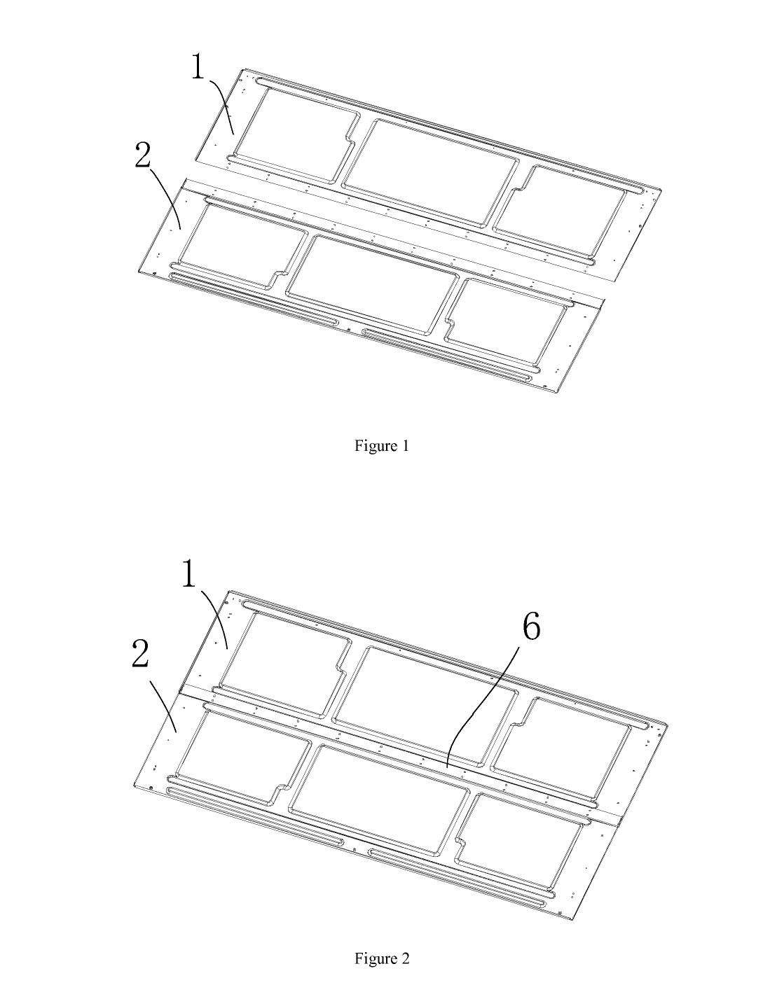

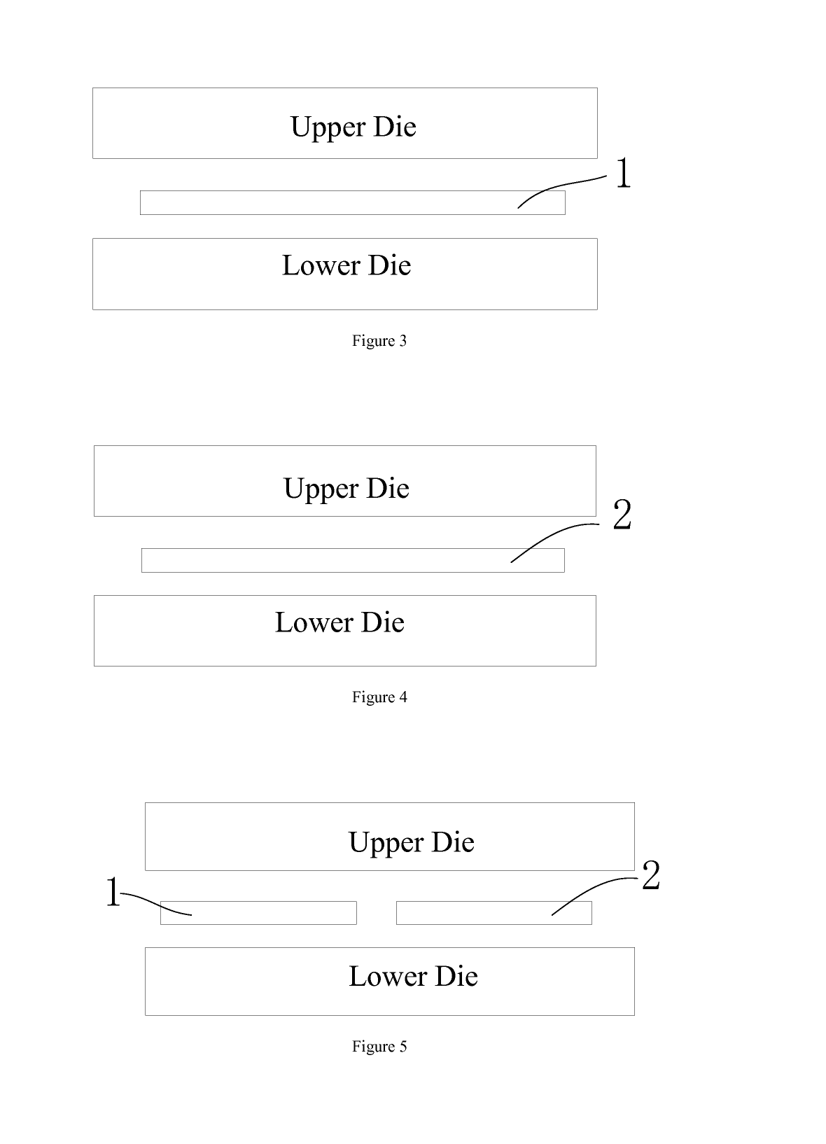

Wherein: 1. heatsink plate; 2. supporting plate; 3. rivet; 4. super glue; 5. screw; 6. reinforcing rib.

### DETAILED DESCRIPTION

The present invention will further be described in detail in accordance with the figures and the preferred examples.

A stamping die of a joining backplane, comprising: a plurality of backplane figures which comprise a plurality of sub backplanes and sub figures in joints. Each sub backplane comprises a heatsink plate 1 and a supporting plate 2 according to the functions of the backplane; the backplane material can be pertinently selected, which is beneficial to cost reduction. Further, the sub figures of the heatsink plate 1 and the supporting plate 2 are identical and the identical sub figures can be simplified in design to reduce the design cost. To enhance the strength of the joining backplane and improve the planeness, the sub figures of the heatsink plate and the supporting plate in the joints comprise figures of reinforcing ribs 6.

As shown in FIG. 5, a processing method of a joining backplane, comprising:

A: Plates of the heatsink plate 1 and the supporting plate 2 are put into the same die for processing;

B: The heatsink plate 1 and the supporting plate 2, which are processed, are joined and fixed.

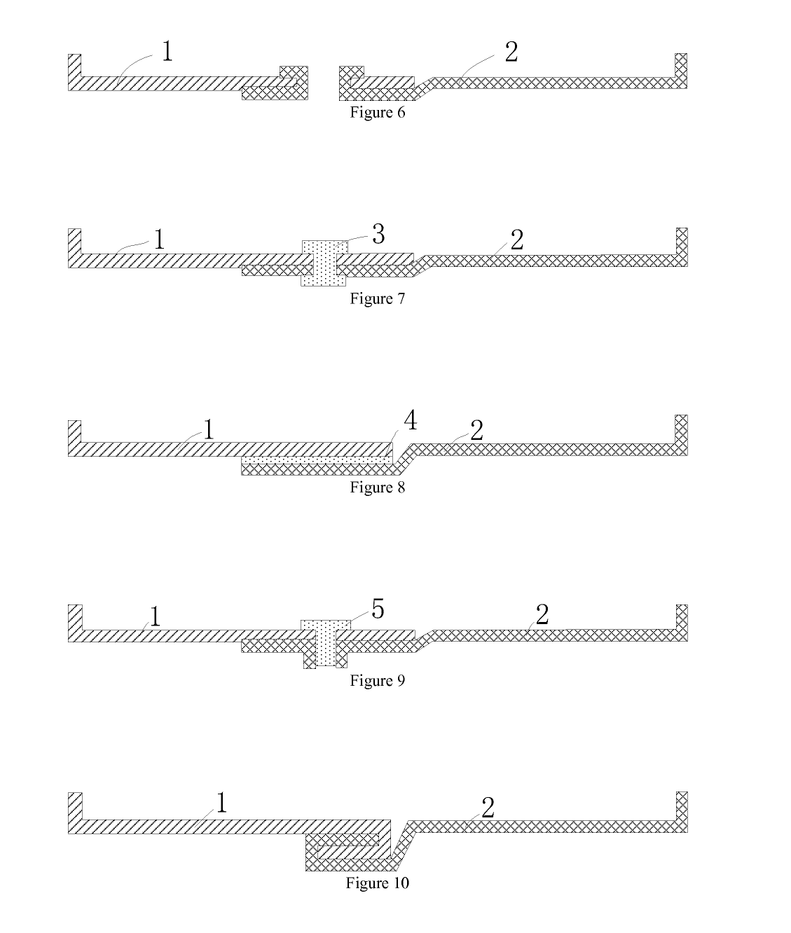

The heatsink plate 1 and the supporting plate 2 can be fixed in the modes of riveting (as shown in FIG. 6 and FIG. 7), bonding by super glue 4 (as shown in FIG. 8), connection through a screw 5 (as shown in FIG. 9), lock seaming connection (as shown in FIG. 10) and the like; the riveting can include riveting without a rivet 3 (as shown in FIG. 6) and riveting with the rivet 3 (as shown in FIG. 7). The fixing mode of the heatsink plate 1 and the supporting plate 2 in the present invention will be further explained below in the lock seaming mode:

As shown in FIG. 10, the heatsink plate 1 and the supporting plate 2 are fixed in the mode of lock seaming mode; the heatsink plate 1 and the supporting plate 2 are folded in the joint to form clamping slots and clamping plates; the clamping plate of the heatsink plate 1 is embedded into the clamping slot of the supporting plate 2; meanwhile, the clamping plate of the supporting plate 2 is also embedded into the clamping slot of the heatsink plate 1 to form the lock seaming connection. In the example, no other fixed material is used, thereby reducing the assembly steps and enhancing the assembly efficiency.

Because the heatsink plate 1 and the supporting plate 2 are simultaneously formed by stamping in the same die, the original processing courses of two plates can be merged; the example of seven projects required for each plate is taken; in the existing procedures, each of the heatsink plate 1 and the supporting plate 2 needs seven projects, and then fourteen projects are needed; when the last joining project is added, fifteen projects in total are needed; thus, a large amount of cost is increased. If the production course of the simplifying technology of the present invention is adopted, only eight projects are needed, so that the number of the projects is greatly reduced, the efficiency is enhanced and the cost is reduced. In addition, because the heatsink plate and the supporting plate are simultaneously processed in the same die, the two plates have good consistency and better planeness in joining.

The present invention is described in detail in accordance with the above contents with the specific preferred examples. However, this invention is not limited to the specific embodiments. For the ordinary technical personnel of the technical field of the present invention, on the premise of keeping the conception of the present invention, the technical personnel can also make simple deductions or replacements, and all of which should be considered to belong to the protection scope of the present invention.

We claim:

1. A stamping die of a joining backplane, comprising: a plurality of backplane figures; said backplane figures comprise a plurality of sub backplanes and sub figures thereof in joints.

2. The stamping die of the joining backplane of claim 1, wherein each said sub backplane comprises a heatsink plate and a supporting plate.

3. The stamping die of the joining backplane of claim 1, wherein sub figures of said heatsink plate and said supporting plate are identical.

4. The stamping die of the joining backplane of claim 1, wherein the sub figures of said heatsink plate and said supporting plate in the joints comprise figures of reinforcing ribs.

5. A processing method of a joining backplane, comprising the following steps:
A: plates of the heatsink plate and the supporting plate are put into the same die for processing;
B: the heatsink plate and the supporting plate, which are processed, are joined and fixed.

6. The processing method of the joining backplane of claim 5, wherein said heatsink plate and said supporting plate are fixed in the mode of riveting.

7. The processing method of the joining backplane of claim 5, wherein said heatsink plate and said supporting plate are fixed in the mode of screwed connection.

8. The processing method of the joining backplane of claim 5, wherein said heatsink plate and said supporting plate are fixed in the mode of bonding by super glue.

9. The processing method of the joining backplane of claim 5, wherein said heatsink plate and said supporting plate are fixed in the mode of lock seaming; said heatsink plate and said supporting plate are folded in the joint to form clamping slots and clamping plates; the clamping plate of said heatsink plate is embedded into the clamping slot of said supporting plate; meanwhile, the clamping plate of said supporting plate is also embedded into the clamping slot of said heatsink plate to form said lock seaming connection.
